(19) United States
(12) Patent Application Publication
(10) Pub. No.: US 2014/0168721 A1
(43) Pub. Date: Jun. 19, 2014

(54) IMAGE PROCESSING APPARATUS, METHOD, AND PROGRAM

(71) Applicant: CANON KABUSHIKI KAISHA, Tokyo (JP)

(72) Inventor: Yukichika Ichihashi, Kawasaki-shi (JP)

(73) Assignee: CANON KABUSHIKI KAISHA, Tokyo (JP)

(21) Appl. No.: 14/103,362

(22) Filed: Dec. 11, 2013

(30) Foreign Application Priority Data
Dec. 19, 2012 (JP) 2012-276770

(51) Int. Cl. H04N 1/10

(52) U.S. Cl. CPC H04N 1/10
USPC 358/474

(57) ABSTRACT

An image processing apparatus comprises a scanning unit that obtains an image by scanning a document, an analyzing unit that analyzes plural portions included in the obtained image, and a displaying unit that displays plural pieces of readability information corresponding respectively to the plural portions, each piece of readability information indicating a readability of one of the plural portions, together with the obtained image on the basis of the analysis by the analyzing unit, wherein the readability is a readability of characters.

### BACKGROUND OF THE INVENTION

1. Field of the Invention

The present invention relates to an image processing system for photographing a printed document by a mobile terminal apparatus.

2. Description of the Related Art

Owing to advancement of a digital camera technique, it is quite common that a printed document image is photographed by using a mobile terminal such as a cellular phone or the like. The mobile terminal can use an Internet environment. Thus, the photographed document image can be printed by a simple operation through a network. That is, so long as there are a mobile terminal and a print environment, the mobile terminal can be used as a simple digital multi-function apparatus. However, if the document image photographed by the mobile terminal is printed as it is, there are various problems such as a geometrical distortion and the like. Japanese Patent Application Laid-Open No. 2011-55467, for example, discloses executing an imaging process to a document image, and then printing the document image.

Some conventional printers have the Nup function (page arranging function), where images of a plurality of pages are reduced and arranged on one sheet of paper and printed in order to save sheets. For example, such printers can perform 4up printing, where images of four pages are arranged on one sheet of paper and printed. According to Japanese Patent Application Laid-Open No. 2011-55467, in the case where the user photographs one sheet of Nup document by a camera equipped for the mobile terminal and prints the photographed document, for example, a printed document image also becomes a page-arranged image (Nup image). In the case where the user feels that a resolution of the image of a portion corresponding to a specific page in the printed document image is low, the user allows the camera of the mobile terminal to approach the portion corresponding to the specific page on the document, photographs the document again, and prints the image of the portion which has been photographed again. Such a situation that the user can confirm the resolution of the image of the portion corresponding to the specific page only after such an image is printed once is troublesome to the user.

### SUMMARY OF THE INVENTION

In order to solve the problems discussed above, the present invention provides an image processing apparatus comprising a scanning unit that obtains an image by scanning a document, an analyzing unit that analyzes plural portions included in the obtained image, and a displaying unit that displays plural pieces of readability information corresponding respectively to the plural portions, each piece of readability information indicating a readability of one of the plural portions, together with the obtained image on the basis of the analysis by the analyzing unit, wherein the readability is a readability of characters

Further features of the present invention will become apparent from the following description of exemplary embodiments with reference to the attached drawings.

### BRIEF DESCRIPTION OF THE DRAWINGS

FIG. 1 is a constructional diagram to use the invention.

FIG. 2A is a diagram of a mobile terminal (front-face) which is used in an embodiment and FIG. 2B is a diagram of the mobile terminal (back-face) which is used in the embodiment.

FIG. 3 is an internal block diagram of the mobile terminal which is used in the embodiment.

FIG. 4 is a whole flowchart which is used in the first embodiment and the second embodiment.

FIG. 5A is an example of a display screen at the time of setting the NUP number and FIG. 5B is an example of a display screen at the time of setting a document size.

FIG. 6A is an example of a display screen of the mobile terminal in the case where four edge portions of a document have been detected in the first embodiment, FIG. 6B is an example of a display screen of the mobile terminal in the case where two edge portions of the document have been detected in the first embodiment, and FIG. 6C is an example of a display screen of the mobile terminal in the case where one edge portion of the document has been detected in the first embodiment.

FIG. 7 is a flowchart for a division number discrimination in the first embodiment.

FIG. 8A is an example of a screen display in a screen 4-division mode which is used in the embodiment, FIG. 8B is an example of a screen display in a screen 2-division mode which is used in the embodiment, and FIG. 8C is an example of a screen display at the time when a document is obliquely photographed in the screen 4-division mode which is used in the embodiment.

FIG. 9 is an example of a flowchart regarding a detection of a high resolution page which is used in the embodiment.

FIG. 10 is a flowchart for a division number discrimination which is used in the second embodiment.

FIGS. 11A, 11B, 11C and 11D are screen display examples of a notifying method of a high resolution page which is used in the embodiment.

### DESCRIPTION OF THE EMBODIMENTS

Exemplary embodiments of the invention will be described hereinbelow with reference to the drawings.

### First Embodiment

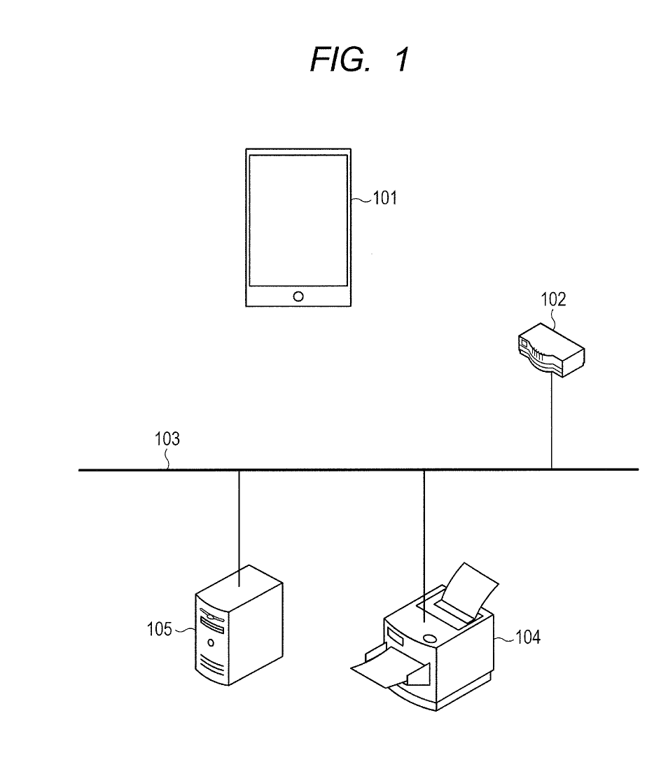

FIG. 1 illustrates a network construction in which a mobile terminal 101 according to the first embodiment is used. The network construction includes a wireless router 102, local area network equipment 103, a printer 104, and a personal computer 105. The mobile terminal 101 functions as an image generating apparatus. The mobile terminal 101, printer 104, and personal computer 105 mutually transmit and receive data through the wireless router 102 and the local area network equipment 103.

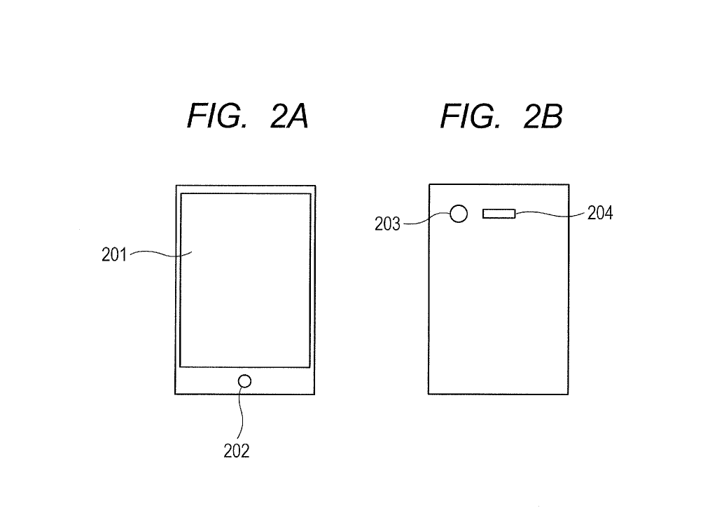

An outline of the mobile terminal according to the embodiment is illustrated in FIGS. 2A and 2B. FIG. 2A illustrates a front face of the mobile terminal 101. A touch screen 201 and an operation button 202 are arranged on the front face. FIG. 2B illustrates a back face of the mobile terminal 101. A camera light receiving unit 203 and an auto-focus device 204 are arranged on the back face. Although various kinds of terminals exist as a mobile terminal, any terminal can be used in the invention so long as it has a camera function. Although the auto-focus device ordinarily measures a focal distance by transmission and reception timing of infrared rays, such a measurement may be realized by various methods such as a method of discriminating it from image data and the like. The auto-focus device, which will be described in the embodiment, is shown as an example and the invention is not limited to it but can be applied to any device so long as it can measure the focal distance.

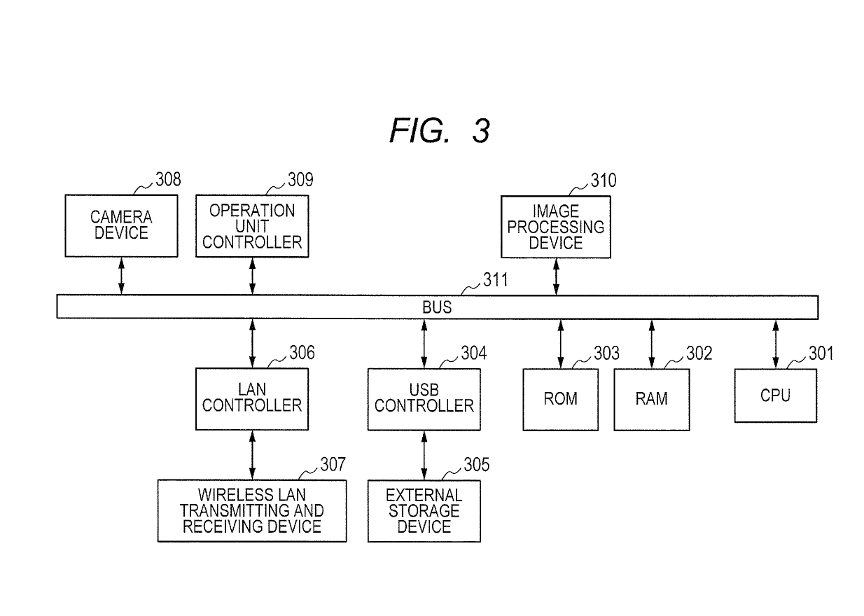

FIG. 3 illustrates an internal construction of the mobile terminal 101. This construction diagram is limited to a construction necessary for the embodiment and is illustrated. In FIG. 3, a CPU 301, a RAM 302, and a ROM 303 transmit and receive a program and data through a data bus 311. An operation unit controller 309, a camera device 308, an image processing device 310, a USB controller 304, and a LAN controller 306 are connected to the data bus 311. The camera device 308 is integrated with the camera light receiving unit 203 and the auto-focus device 204 in FIGS. 2A and 2B. Further, the LAN controller 306 is connected to a wireless LAN transmitting and receiving device 307 and can transmit and receive data to/from the wireless router 102.

The whole operation of the embodiment will be described. First, image data of a document photographed by the mobile terminal 101 is transmitted to the wireless router 102 by using the wireless LAN transmitting and receiving device 307. The wireless router 102 transmits the received image data to the personal computer 105 through the local area network equipment 103. The personal computer 105 transfers the received image data to the printer 104, thereby printing it. By the above operation, the image photographed by the camera by using the mobile terminal can be printed. Even if it is not printed, the image data may be stored as a file into a storage device (not shown) built in the personal computer 105. At this time, the image data may be used as a PDF file.

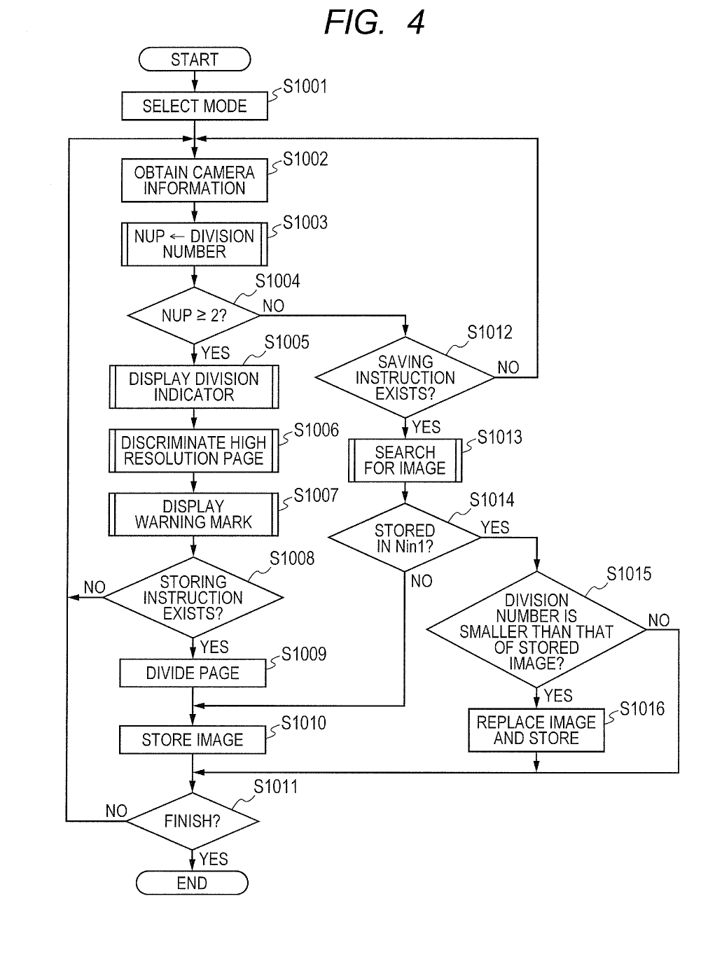

Subsequently, the embodiment will be described in detail with reference to a flowchart of FIG. 4. The flowchart of FIG. 4 has been stored as a program in the ROM 303. The CPU 301 executes the program by using the RAM 302. Therefore, in the subsequent description, it is assumed that the CPU 301 executes the program unless otherwise specified.

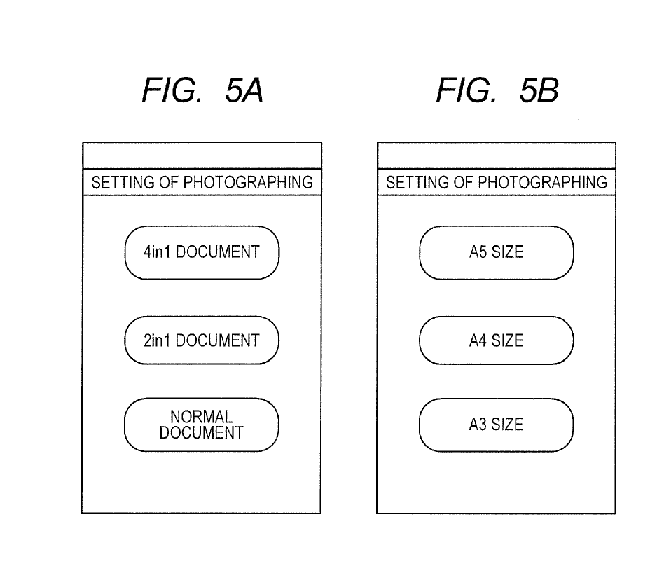

First, in S1001, a screen to select the number N of pages arranged on one page (hereinbelow, referred to as the number N) of a page arranged document (Nup document) to be photographed is displayed on the touch screen 201 by using the operation unit controller 309. For example, the number N is displayed as illustrated in FIG. 5A, thereby promoting the user to touch the display screen. At this time, if the document to be photographed is a 4up (images of 4 pages are printed onto one sheet: the number N is equal to 4) document, the user touches “4in1 document” and selects. If the document is a 2up (images of 2 pages are printed onto one sheet: the number N is equal to 2) document, the user selects “2in1 document”. If the document is a document in which pages are not arranged on one page (image of 1 page is printed onto one sheet: the number N is equal to 1), the user selects “normal document”. As mentioned above, the number N is selected by the user and the photographing mode corresponding to the number N is selected. Further, the operation unit controller 309 notifies the CPU 301 of the number N selected by the user. The number N is stored into the RAM 302.

In S1002, camera information (image data photographed by the camera light receiving unit 203) is obtained from the camera device 308 and stored into the RAM 302. The operation unit controller 309 reads out the image data from the RAM 302 and displays onto the touch screen 201.

In S1003, the division number is discriminated by using the image data and the number N stored in the RAM 302. In the division number discrimination, how many pages (it is certainly equal to or less than N pages) in the Nup document displayed on the touch screen 201 of the mobile terminal have been displayed by the process of S1002 is discriminated. By this discrimination, into which number of pages the page should be divided when the image data is stored can be known. The pages in the Nup document which is displayed in this instance denote an image of each page arranged on one sheet of document. For example, if the whole 4up document is displayed on the touch screen 201, four pages can be photographed by the camera device 308. If the mobile terminal and the document are sufficiently away from each other in order to photograph the whole document, three or more of four edge portions of the document are displayed on the touch screen 201. The edge portions of the document mentioned here (document edge portions) denote corners of the document sheet.

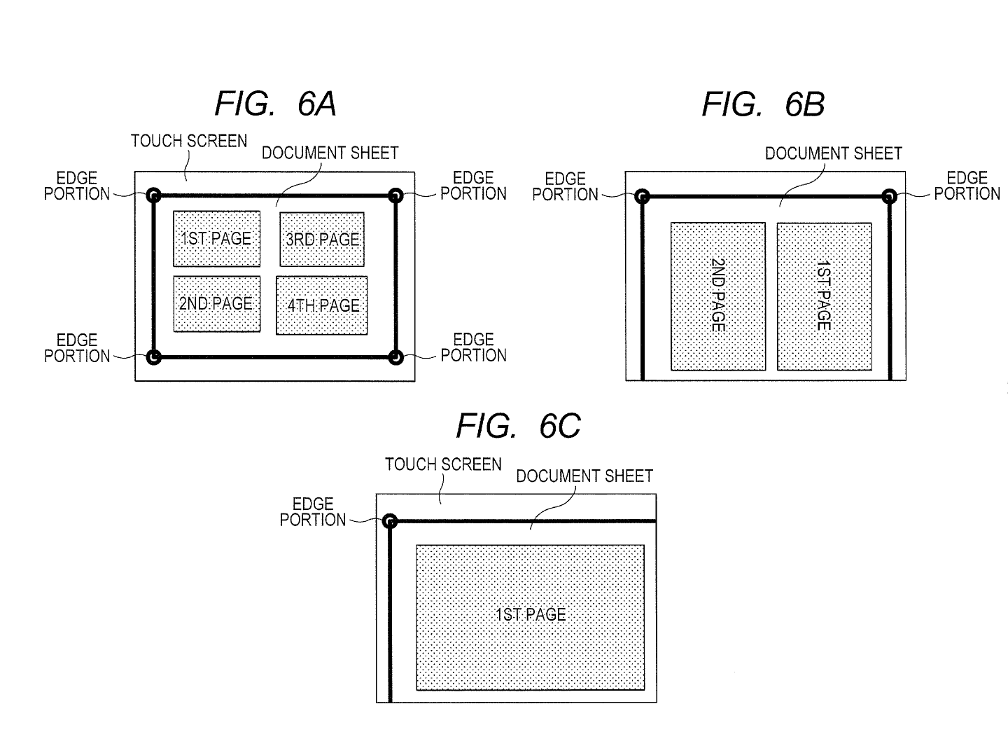

FIGS. 6A to 6C illustrate states where the number of pages which are displayed on the touch screen 201 differs in dependence on a distance between the document and the camera light receiving unit 203. FIG. 6A is an example of an image displayed on the touch screen 201 in the case where the Nup document and the camera light receiving unit 203 are sufficiently away from each other. The whole document is displayed and the four document edge portions are displayed on the touch screen. FIG. 6B is an example of an image displayed on the touch screen 201 in the case where the Nup document and the camera light receiving unit 203 are slightly away from each other. The half of the 4up document is displayed on the touch screen 201 and two of the four edge portions of the document are displayed on the touch screen 201. FIG. 6C is an example of an image displayed on the touch screen 201 in the case where the camera light receiving unit 203 approaches the Nup document. The quarter of the 4up document is displayed on the touch screen 201 and one of the four edge portions of the document is displayed on the touch screen 201.

As described above, the number of edge portions of the document differs in dependence on a mode in which the whole Nup document is photographed or a mode in which a part of the document (some of the pages of the document) is photographed. Therefore, in the embodiment, the number of pages in the display screen is discriminated on the basis of the number of edge portions of the document.

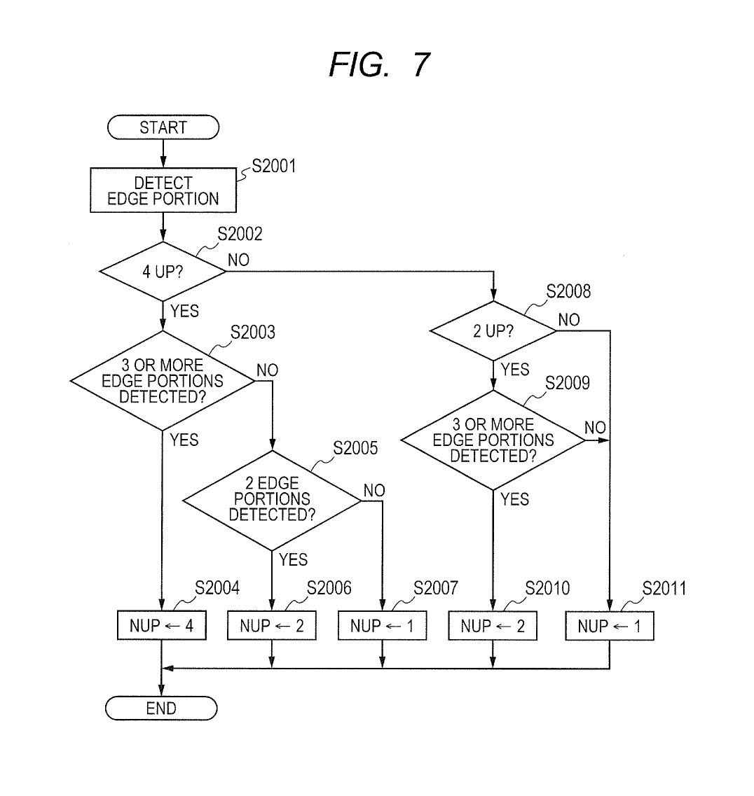

FIG. 7 is a flowchart in the case where a method of detecting the edge portions of the document as mentioned above is used as a discriminating method in S1003. First, in S2001, the document edge portions are detected from the image data. As for the detecting method of the document edge portions, various methods have been proposed as an extraction of a feature amount. For example, generally, there is used a method whereby an edge extraction filter such as Laplacian or the like is applied to the image data, a pattern matching process of a pattern which crosses an edge image at a right angle later is executed after that, and the document edge portions are found. In recent years, an ORB feature amount detector or an SIFT feature amount detector is famous. In the embodiment, however, since a feature amount detector for realizing the detection of the document edge portions is not particularly limited, its detailed description is omitted here.

Subsequently, in S2002, the processing routine is branched in accordance with the number N stored in the RAM 302. If the number N is equal to 4up, the processing routine advances to S2003. In S2003, whether or not the number of detected edge portions is equal to or larger than 3 is discriminated. If it is equal to or larger than 3, 4 is substituted into a variable NUP in S2004. If three or more edge portions are not detected in S2003, S2005 follows. In S2005, whether or not the number of detected edge portions is equal to or larger than 2 is discriminated. If it is equal to 2, 2 is substituted into the variable NUP in S2006. In S2005, if the number of detected edge portions is less than 2, 1 is substituted into NUP in S2007.

Further, if the number N stored in the RAM 302 is not equal to 4up in S2002, S2008 follows and whether or not it is equal to 2up is discriminated. If it is equal to 2up, S2009 follows and whether or not the number of detected document edge portions is equal to or larger than 3 is discriminated. If it is equal to or larger than 3, 2 is substituted into the variable NUP in S2010. This is because if the whole 2up document has been photographed, the division number is equal to 2. On the other hand, if it is not equal to 2up (pages are not arranged on one page) and if only two or less edge portions have been detected in S2009, 1 is substituted into NUP in S2011. This is because in the case where the pages are not arranged on one page and the case where the half of the 2up document has been photographed, there is no need to divide the page.

By the process of S1003 mentioned above, the number of photographed pages is substituted into the variable NUP. Subsequently, in S1004, whether or not a value of NUP as a discrimination result of S1003 is equal to or larger than 2 is discriminated. If it is equal to or larger than 2, S1005 follows. In other cases, S1012 follows.

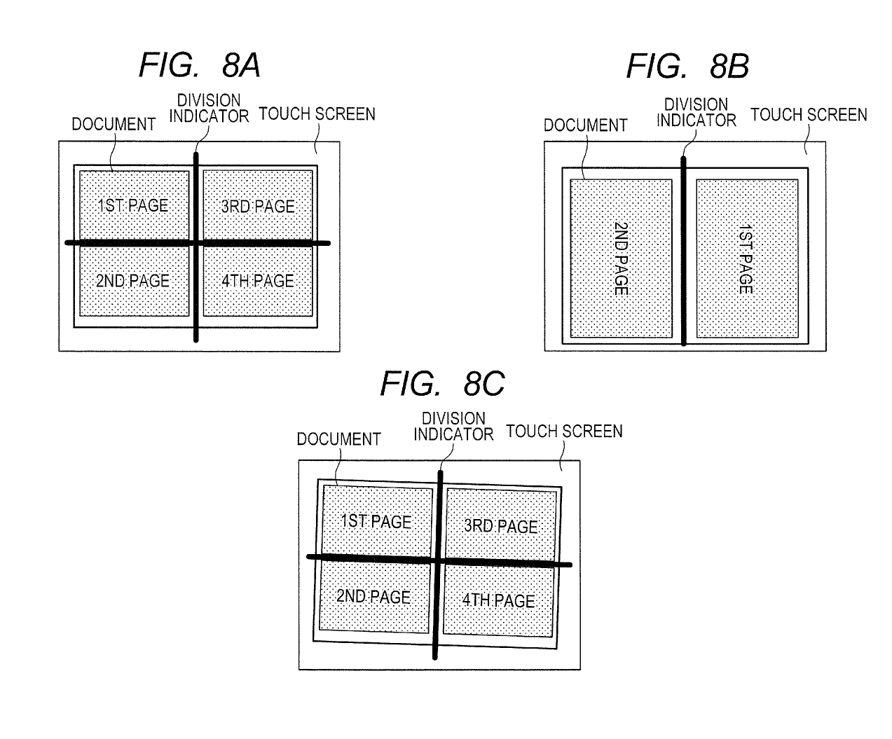

In S1005, a division area notification image (hereinbelow, referred to as a division indicator) is formed and the image data and the division indicator are combined and displayed onto the touch screen 201 of the mobile terminal. Examples of the division indicator are illustrated in FIGS. 8A to 8C. This division indicator is an image for notifying the user of an area of each page image in the Nup document. In the example of FIG. 8A, the division indicator is an image of straight lines which cross at right angles. In the example of FIG. 8B, the division indicator is an image of a straight line. The image of the Nup document is divided into each area by such a division indicator. FIG. 8A is an example of the touch screen 201 in which the image data and the division indicator are combined in the case where NUP is equal to 4. FIG. 8B is an example of the touch screen 201 in which the image data and the division indicator are combined in the case where NUP is equal to 2. As mentioned above, in the embodiment, the division indicator is arranged on the display screen of the mobile terminal at a right angle. However, for example, if coordinates of all of the document edge portions illustrated in FIG. 6A are obtained in S1003, the division indicator may be obliquely combined to the image data in consideration of the positions of the document edge portions as illustrated in an example of FIG. 8C.

Subsequently, in S1006, a high resolution page is discriminated. In the high resolution page discrimination, to the image of each area divided by the division indicator displayed in S1005, a resolution of an image which is desirable to the printing of the image of each area is discriminated. Ordinarily, in the case where the Nup document photographed by the camera is divided and printed, an enlargement printing is performed. At this time, in the case of an image obtained by photographing a small point character from a remote place, the camera cannot resolve a line constructing the character and cannot perform the detailed printing in which the resolution of the image is high. On the other hand, in the case of a large point character, a photograph image, or a simple graphic image, the detailed printing in which the image can be sufficiently discriminated can be performed. From the above reasons, whether or not the subject image data can be beautifully printed in the enlargement printing is discriminated.

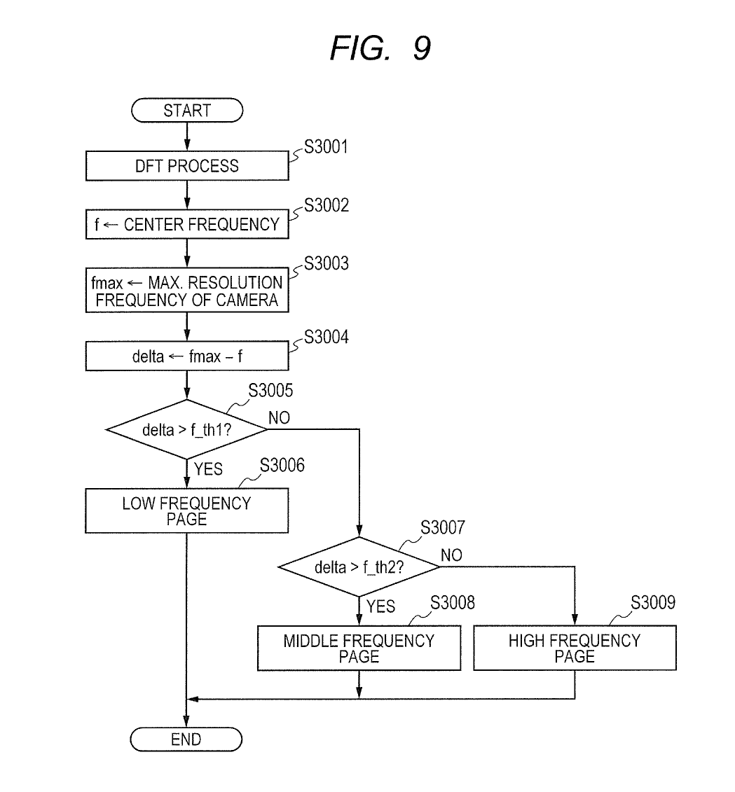

A flowchart for the high resolution page discriminating method in S1006 is illustrated in FIG. 9. It is now assumed that the first quadrant of the four divided area in FIG. 8A is an upper left area, the second quadrant is a lower left area, the third quadrant is an upper right area, and the fourth quadrant is a lower right area. It is now assumed that the resolution discrimination is sequentially performed with respect to the first to fourth quadrants.

First, in S3001, a DFT (digital Fourier transformation) process is executed to the first quadrant of the image data. Thus, a frequency component of the image data of the first quadrant is extracted. In S3002, a component of the center frequency (power is high) among the frequencies is obtained and is substituted into a variable f. In S3003, a frequency which is desirable to print a high resolution image is obtained and is assumed to be “fmax”. Since it is necessary to prepare fmax, it has been stored in the ROM 303. Since fmax varies in dependence on performance such as resolution, the number of pixels, or the like of the camera, it is necessary to previously decide its value at the time of development of the mobile terminal 101.

In S3004, a difference between fmax and f is assumed to be “delta”. Namely, a comparison is made between the frequency as required and the frequency of the image. In S3005, whether or not delta is larger than a threshold value “f_th1” is discriminated. If it is larger than f_th1, it is possible to determine that the frequency of the image data is low. In such a case, the CPU 301 decides that the first quadrant is a low frequency page. In S3006, the first quadrant is set as a low frequency page. The image of the low frequency page is, for example, such an image that a character of a large size is included. It is such an image that even in the case where the document is photographed so that the whole document is included in the photographed image, the user can relatively clearly discriminate the contents of the document.

If delta is equal to or less than f_th1 in S3005, in S3007, whether or not delta is larger than another threshold value “f_th2” smaller than f_th1 is discriminated. If it is determined that delta is larger than f_th2, there is a possibility that a high frequency image which cannot be resolved is included. In such a case, the CPU 301 decides that the first quadrant is a middle frequency page. In S3008, the first quadrant is set as a middle frequency page. The image of the middle frequency page is, for example, such an image that a character of about a middle size is included. That is, it is such an image that in the case where the document is photographed so that the whole document is contained in the photographed image, it is difficult for the user to discriminate the contents of the document in dependence on photographing conditions or the document contents. Therefore, the image of the middle frequency page is such an image that it is necessary to warn the user that there is a possibility that the high resolution detailed image cannot be printed by the printer 104. If delta is equal to or less than f_th2 in S3007, in S3009, the CPU 301 decides that the first quadrant is a high frequency page. The image of the high frequency page is, for example, such an image that a character of a very small size is included. That is, it is such an image that in the case where the document is photographed so that the whole document is contained in the photographed image, it will be more impossible for the user to discriminate the contents of the document than the image of the middle frequency page. Therefore, the image of the high frequency page is such an image that even if the image of the high frequency page is printed by the printer 104, since it is presumed that the high resolution detailed image cannot be printed, it is necessary to promote the user to approach the document and photograph it.

The processes of S3001 to S3009 are repeated with respect to the second to fourth quadrants. In the case where the image data divided into each quadrant is printed by the printer 104 as mentioned above, whether or not the high resolution detailed image can be printed is discriminated.

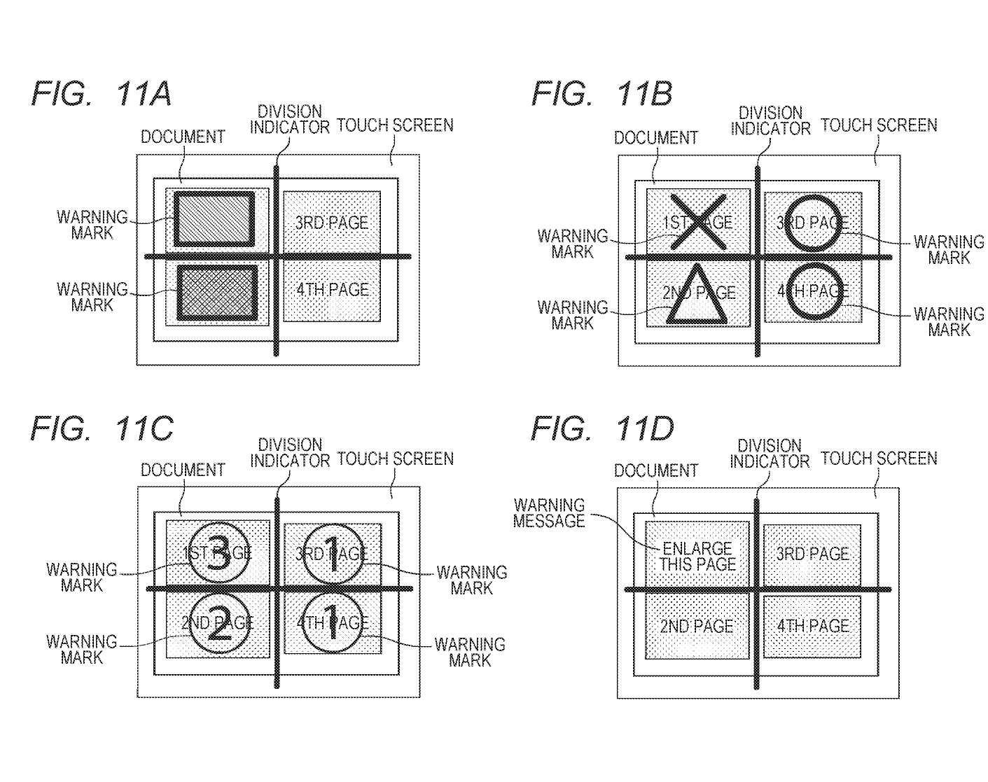

Returning to FIG. 4, in S1007, information showing whether or not it is necessary to photograph again in order to raise the resolution of the image for the quadrants of the high frequency page determined in S1006 with respect to the first to fourth quadrants in FIG. 8A is notified to the user. This notification is performed by combining a warning mark with the image and displaying onto the touch screen 201. By this notification, when the image is printed, the user can discriminate the page which cannot be resolved (page in which the resolution of the image is too low). Examples of the warning mark are illustrated in FIGS. 11A to 11D. “Page” mentioned here denotes each page image arranged on the Nup document. In FIG. 11A, warning information of a page to be photographed again is displayed by changing a display color or a hatching pattern. In FIG. 11B, warning information of a page to be photographed again is displayed by symbols. In FIG. 11C, warning information of a page to be photographed again is displayed by adding numbers. In FIG. 11D, a warning message is displayed. The invention is not limited to such a method as mentioned above but any warning method may be used. The middle frequency page may be similarly warned. In the case of warning the high frequency page and the low frequency page, it is desirable to change a type of warning information in accordance with the frequency of each page. In FIG. 11A, for example, a red semitransparent rectangular image is superimposed to the high frequency page shown as a top-left area in FIG. 11A, a yellow semitransparent rectangular image is superimposed to the middle frequency page shown as a bottom-left area in FIG. 11A, and a resultant image is displayed.

In S1008, the operation unit controller 309 obtains a storing instruction from the user. If there is no storing instruction, the processing routine is returned to S1002. If the storing instruction has been input, the processing routine advances to S1009. In S1009, the image is divided in accordance with the areas divided by the division indicator in FIGS. 8A to 8C and header information such as a page number or the like is added to each page. At this time, as for order of the pages, the operation unit controller 309 transfers the instruction of the user which is input to the touch screen 201 to the CPU 301. For example, the operation unit controller 309 shows the page number of each quadrant in FIGS. 8A to 8C displayed on the touch screen 201 to the user, and the CPU 301 corrects the page number on the basis of the input information showing whether or not the page number is correct or whether or not the user wants to correct it. In such a case where the page number has been allocated to each page, it is also possible to discriminate a peripheral area of a lower portion of each page by an OCR and extract the page numbers as candidates.

After the division, a process such as trimming or resolution change is executed to each page by the image processing device 310 in FIG. 3. By detecting the image area of each page, the trimming can be performed with respect to an area out of the image area. In the invention, an image size of each page changes in accordance with the division number. To align the image size, for example, in the case of the 4 divided pages, by doubling each of the vertical and lateral sizes, the image size can be returned to the original size. As for the resolution change, the resolution may be matched with a print resolution of the printer 104. For example, when the image obtained by photographing the document at a resolution of about 300 dpi and dividing into four areas is printed by the printer of 600 dpi, the image is enlarged by 8 times.

Subsequently, in S1010, a plurality of divided images are stored into the RAM 302. In S1011, whether or not the process is finished is discriminated. If the operation unit controller 309 received an end instruction from the user on the touch screen 201, the processing routine is finished. In the case of continuing the photographing without finishing the process, the processing routine is returned to S1002.

When NUP is equal to 1 in S1004, the processing routine advances to S1012. Since S1012 is substantially the same process as S1008, its description is omitted. Subsequently, in S1013, the new image data is compared with the old image data which has already been stored in the RAM 302 in S1010, thereby discriminating whether or not they are the same page. As a method of discriminating whether or not they are the same page, there are various methods. For example, generally, there is used a method whereby a correlation coefficient of normalized histograms of the old image data and the new image data is obtained and whether or not the correlation coefficient is close to 1 is discriminated. If it is close to 1, this means that they are the same page. If it is far from 1, this means that they are different pages. However, as a method of discriminating whether or not the images are identical, various methods have been proposed. The invention is not limited to a specific discriminating method.

In S1014, if the image data of the same page is not found in the RAM 302 as a search result of S1013, the processing routine advances to S1010. The page number is added after the stored image data and the image is added. If it is determined in S1014 that the image data has been stored as a search result of S1013, which one of the resolution of the stored image and the resolution of the new image is higher is discriminated in S1015. As a discriminating method, for example, at the time of image storage in S1010, the value of NUP is also stored as additional information and NUP of the new image is compared with NUP of the stored image. If NUP of the new image is lower, this means that the division number is small and the resolution is high. Therefore, in S1016, the stored image is replaced with an image in which a numerical value of the division number NUP is smaller than that of the stored image and stored. When the image is replaced in S1016, the header information such as a page number or the like of the image before the replacement is added to the image which is used for the replacement.

By the above process, the page-divided image data is formed in order. The images of a plurality of pages formed in the flow of FIG. 4 are transferred from the RAM 302 of the mobile terminal 101 to the personal computer 105 through the wireless router 102 and the local area network equipment 103 by using the wireless LAN transmitting and receiving device 307. In the personal computer 105, the resolution of the transferred images are changed to the resolution suitable for printing and the image data is transferred to the printer 104. The printer 104 executes a halftone process and prints.

As described above, in the embodiment, when the image of the Nup document is photographed by the mobile terminal, the user can photograph and print the image at a proper resolution.

### Second Embodiment

In the second embodiment, the division number discrimination in S1003 in FIG. 4 is performed by a method different from that of the first embodiment. Only a portion different from the first embodiment will be described hereinbelow.

First, in S1001 in FIG. 4, a screen of FIG. 5A is displayed on the touch screen 201 of the mobile terminal 101 and the number N is stored into the RAM 302. Further, a screen of FIG. 5B is displayed on the touch screen 201 and a setting of a sheet size of the document to be photographed is stored into the RAM 302.

Subsequently, in S1002, camera information (image data photographed and received by the camera light receiving unit 203) is obtained from the camera device 308 and stored into the RAM 302. The operation unit controller 309 reads out the image data from the RAM 302 and displays onto the touch screen 201. Further, a focal distance is obtained from the camera device 308 by using an auto-focus function of the auto-focus device 204. The focal distance is a distance between a photographing subject to be measured by the auto-focus function and a photosensing element of the camera. Therefore, a distance L (cm) between the mobile terminal and the document can be measured by using the focal distance.

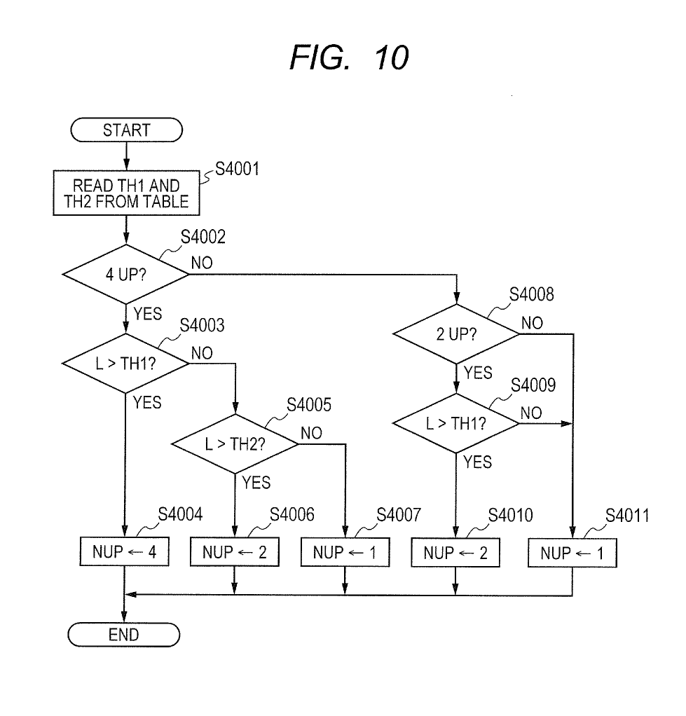

The division number discriminating process of S1003 will be described with reference to a flowchart of FIG. 10. In S4001 in FIG. 10, threshold values TH1 and TH2 are obtained from a table stored in the ROM 303 by using the setting of the document size stored in the RAM 302. It is now assumed that there is certainly a relation of (TH1>TH2). TH1 indicates a distance necessary to photograph the whole document. TH2 indicates a distance necessary to photograph the half of the document. An example of the table stored in the ROM 303 is shown below.

| | Document Size | | |
|---|---|---|---|
| Threshold Value Table | A3 | A4 | A5 |

| | | | | |
|---|---|---|---|---|
| Threshold Value | TH1 (cm) | 50 | 30 | 15 |
| | TH2 (cm) | 30 | 15 | 8 |

Subsequently, in S4002, whether or not the number N stored in the RAM 302 is equal to 4up is discriminated. If it is equal to 4up, in S4003, the distance L between the mobile terminal and the document is compared with TH1. If the distance L is larger than TH1, it is determined that the whole document has been photographed. Therefore, in S4004, 4 is substituted into the variable NUP.

In S4003, if the distance L is equal to or less than TH1, S4005 follows. In S4005, the distance L is compared with TH2. If L is larger than TH2, the camera light receiving unit 203 determines that the half of the document has been photographed. Therefore, in S4006, 2 is substituted into the variable NUP. In S4005, if L is equal to or less than TH2, since it is possible to decide that the image has been further enlarged, in S4007, 1 is substituted into the variable NUP.

In S4002, if the number N stored in the RAM 302 is not equal to 4up, S4008 follows. In S4008, whether or not N is equal to 2up is discriminated. If it is equal to 2up, in S4009, the distance L is compared with TH1. If the distance L is larger than TH1, the camera light receiving unit 203 determines that the whole document has been photographed. In S4010, 2 is substituted into NUP. When the number N stored in the RAM 302 is not equal to 2up in S4008 and when L is equal to or less than TH1 in S4009, it is determined that the image of one page has been photographed. Therefore, in S4011, 1 is substituted into the variable NUP.

Since processes in S1004 and subsequent steps are substantially the same as those in the first embodiment, their description is omitted here.

As described above, in S1003 of the second embodiment, there is no need to obtain edge portion information of the document from the image data displayed on the touch screen 201. Therefore, a high speed process can be executed as compared with the first embodiment. Further, according to the second embodiment, when the Nup document image is photographed by the mobile terminal, the user can be guided so that he can photograph the image at a proper resolution.

As described above, when the Nup document image is photographed by the mobile terminal, the user can be guided so that he can photograph the image at a proper resolution.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-276770, filed Dec. 19, 2012, which is hereby incorporated by reference herein in its entirety.

What is claimed is:

1. An image processing apparatus comprising:
a scanning unit configured to obtain an image by scanning a document;
an analyzing unit configured to analyze plural portions included in the obtained image; and
a displaying unit configured to display plural pieces of readability information corresponding respectively to the plural portions, each piece of readability information indicating a readability of one of the plural portions, together with the obtained image on the basis of the analysis by the analyzing unit, wherein the readability is a readability of characters.

2. The apparatus according to claim 1, wherein the displaying unit comprises:
a superimposing unit configured to superimpose an image which represents the piece of readability information on an image of the corresponding portion respectively; and
an image displaying unit configured to display the superimposed image.

3. The apparatus according to claim 1, further comprising:
a accepting unit configured to accept an instruction from a user after the displaying unit displays the readability information; and
a storing unit configured to store the document image obtained in correspondence to the accepted instruction by the scanning unit.

4. The apparatus according to claim 1, wherein the analyzing unit comprises:
a dividing unit configured to divide the obtained image into plural images corresponding respectively to the plural portions; and
a frequency obtaining unit configured to obtain a frequency of each of the divided images.

5. The apparatus according to claim 4, further comprising:
a storing unit configured to store each of the plural images;
a selecting unit configured to select one of the stored plural images, the selected image corresponding to a predetermined portion included in the obtained image; and
a replacing unit configured to replace the selected image with another image corresponding to the predetermined portion newly obtained by the scanning unit.

6. An image processing method comprising:
obtaining an image by scanning a document;
analyzing plural portions included in the obtained image; and
displaying plural pieces of readability information corresponding respectively to the plural portions, each piece of readability information indicating a readability of one of the plural portions, together with the obtained image on the basis of the analysis, wherein the readability is a readability of characters.

7. A non-transitory computer readable storage medium storing a computer program for causing a computer to execute the image processing method according to claim 6.
